(19) United States
(12) Patent Application Publication
(10) Pub. No.: US 2025/0167888 A1
(43) Pub. Date: May 22, 2025

(54) OPTICAL TRANSMISSION SYSTEM AND FAILURE POINT IDENTIFYING METHOD

(71) Applicant: Nippon Telegraph and Telephone Corporation, Tokyo (JP)

(72) Inventors: Hiroki DATE, Musashino-shi, Tokyo (JP); Takashi KUBO, Musashino-shi, Tokyo (JP); Kohei WATANABE, Musashino-shi, Tokyo (JP); Kenichi AOYAGI, Musashino-shi, Tokyo (JP); Daisaku Shimazaki, Musashino-shi, Tokyo (JP); Hideki Maeda, Musashino-shi, Tokyo (JP)

(21) Appl. No.: 18/840,132

(22) PCT Filed: Feb. 25, 2022
(86) PCT No.: PCT/JP2022/008096

§ 371 Date: Aug. 21, 2024

(51) Int. Cl. H04B 10/079

(52) U.S. Cl. CPC H04B 10/0791

(57) ABSTRACT

An optical transmission system includes nodes connected to each other by optical transmission lines, and includes: monitoring parts each configured to collect signal information in time series at at least one signal collection point of a transmission end of a respective node, a reception end of the respective node, and a location at or between devices in the respective node; and an operation system configured to control the monitoring parts. The operation system extracts a component estimated to include a failure location by causing the monitoring parts to observe signal information on a reception end of a component, and, in the component, identifies the failure location by causing the monitoring parts to observe a temporal change of the signal information at the signal collection point to detect an abnormality.

### DESCRIPTION

### Technical Field

The present invention relates to a technique of an optical transmission system and a failure location identification method.

### Background Art

In an optical transmission system, nodes (devices) serving as a plurality of communication devices are connected to each other with optical transmission lines (optical fibers). Specifically, as illustrated in FIG. 1, an optical transmission system 10 has a hierarchical structure in which an L0/L1 network, a lower layer in which multiple number of various devices are connected to each other, and an L2/L1.5 network and an L3 network, upper layers, are further connected to each other (see FIG. 1). In the optical transmission system, optical physical characteristics and analog control characteristics interact with each other in a complicated manner. Thus, when a failure (abnormality) has occurred, it may be difficult to identify the location and the cause thereof. In recent years, optical transmission systems have further increased in capacity and area, and thus the magnitude of the influence of a failure is likely to increase, and it is difficult to identify failure locations. Due to this, it is required that the maintenance and operations of an optical transmission system detect failures early and identify the locations thereof with high accuracy.

In view of this, there have been developed methods of automatically detecting a failure in an optical transmission system and identifying the location thereof. For example, Patent Literature 1 discloses a method of narrowing down the scope of a failure-suspected area according to packet loss information of an upper layer and allocation relationships among optical-channel data unit (ODU) paths. Patent Literature 2 discloses a method of narrowing down the scope of the suspected area at the level of optical paths based on the optical signal characteristics at a reception end of an optical path such as an optical multiplex section (OMS) and on allocation relationships among optical transport unit (OTU) paths and further identifying the suspected area in the optical path based on optical signal characteristic information.

### CITATION LIST

### Patent Literature

Patent Literature 1: JP 2018-64160 A

Patent Literature 2: JP 2020-88628 A

### SUMMARY OF THE INVENTION

### Technical Problem

However, the method described in Patent Literature 1 can only narrow down the scope of the suspected area only to an OMS section (the region surrounded by the dotted line in FIG. 1) where an Add/Drop of an optical channel of a specific wavelength occurs and the allocation relationship changes. As the method described in Patent Literature 2 identifies the suspected area in the optical path based on the optical signal characteristics only at the reception end, the accuracy is insufficient.

In view of the above problems, an object of the present invention is to identify a failure location in an optical transmission system with high accuracy.

### Solution to Problem

In order to solve the above problem, the present invention has the following feature.

An optical transmission system according to the present invention includes a plurality of nodes connected to each other by optical transmission lines. The optical transmission system includes monitoring means respectively provided in the nodes and configured to collect signal information in time series at at least one signal collection point of a transmission end and a reception end of the respective node and a location at or between devices in the respective node: and control means for controlling the monitoring means, wherein the control means performs: a failure-suspected component extraction process of, for a component including one or more nodes and an optical transmission line between the nodes, causing the monitoring means to observe signal information on a reception end of the component to extract a component estimated to include a failure location, and a failure location identification process of identifying the failure location in the extracted component by causing the monitoring means to observe a temporal change of the signal information at the signal collection point in the respective node to detect an abnormality of the temporal change of the signal information.

### Advantageous Effects of Invention

According to the present invention, it is possible to identify a failure location with high accuracy in an optical transmission system.

### BRIEF DESCRIPTION OF DRAWINGS

FIG. 1 is a diagram illustrating an example of the configuration of an optical transmission system.

FIG. 2 is a diagram illustrating a model of an optical transmission network.

FIG. 3 is a diagram of a portion including a failure-suspected component of the optical transmission system.

FIG. 4A is a graph illustrating an example of a temporal change in the signal quality at a reception end of the failure-suspected component.

FIG. 4B is a graph illustrating an example of a temporal change in the signal quality at a reception end of the failure-suspected component.

FIG. 5 is a diagram illustrating a state of a temporal change in the optical signal power at each signal collection terminal in the failure-suspected component.

FIG. 6A is a graph illustrating an example of a temporal change in normal signal power at a signal collection terminal of the failure-suspected component.

FIG. 6B is a graph illustrating an example of a temporal change in abnormal signal power at a signal collection terminal of the failure-suspected component.

FIG. 6C is a graph illustrating an example of a temporal change in abnormal signal power at a signal collection terminal of the failure-suspected component.

FIG. 7A is a graph illustrating an example of a temporal change in normal signal power at a signal collection terminal of the failure-suspected component.

FIG. 7B is a graph illustrating an example of a temporal change in abnormal signal power at a signal collection terminal of the failure-suspected component.

FIG. 7C is a graph illustrating an example of a temporal change in abnormal signal power at a signal collection terminal of the failure-suspected component.

FIG. 8 is a diagram illustrating a state of a temporal change in the optical signal power at each signal collection terminal of the failure-suspected component.

FIG. 9 is a diagram illustrating a state of a temporal change in the optical signal power at each signal collection terminal of the failure-suspected components.

FIG. 10 is a diagram illustrating a state of a temporal change in the optical signal power, waveform, and OSNR at each signal collection terminal in the failure-suspected component.

FIG. 11A is a graph illustrating an example of the optical spectrum of a normal signal at a signal collection terminal of the failure-suspected component.

FIG. 11B is a graph illustrating an example of the optical spectrum of an abnormal signal at a signal collection terminal of the failure-suspected component.

FIG. 12 is a diagram illustrating a state of a temporal change in the optical signal power, waveform, and OSNR at each signal collection terminal in the failure-suspected component.

FIG. 13A is a graph illustrating an example of the optical spectrum of a normal signal at a signal collection terminal of the failure-suspected component.

FIG. 13B is a graph illustrating an example of the optical spectrum of an abnormal signal at a signal collection terminal of the failure-suspected component.

FIG. 14A is a diagram illustrating a state of a temporal change in the optical signal power, waveform, and OSNR at each signal collection terminal in the failure-suspected component.

FIG. 14B is a diagram illustrating a state of a temporal change in the optical signal power, waveform, and OSNR at each signal collection terminal in the failure-suspected component.

FIG. 15 is a diagram illustrating a state of a temporal change in the optical signal power, waveform, and OSNR at each signal collection terminal in the failure-suspected component.

FIG. 16 is a diagram illustrating a state of a temporal change in the optical signal power, waveform, and OSNR at each signal collection terminal in the failure-suspected component.

FIG. 17 is a diagram of a portion including failure-suspected components of an optical transmission system.

### DESCRIPTION OF EMBODIMENTS

Hereinafter, an embodiment of the present invention will be described in detail with reference to the drawings.

### [Optical Transmission System]

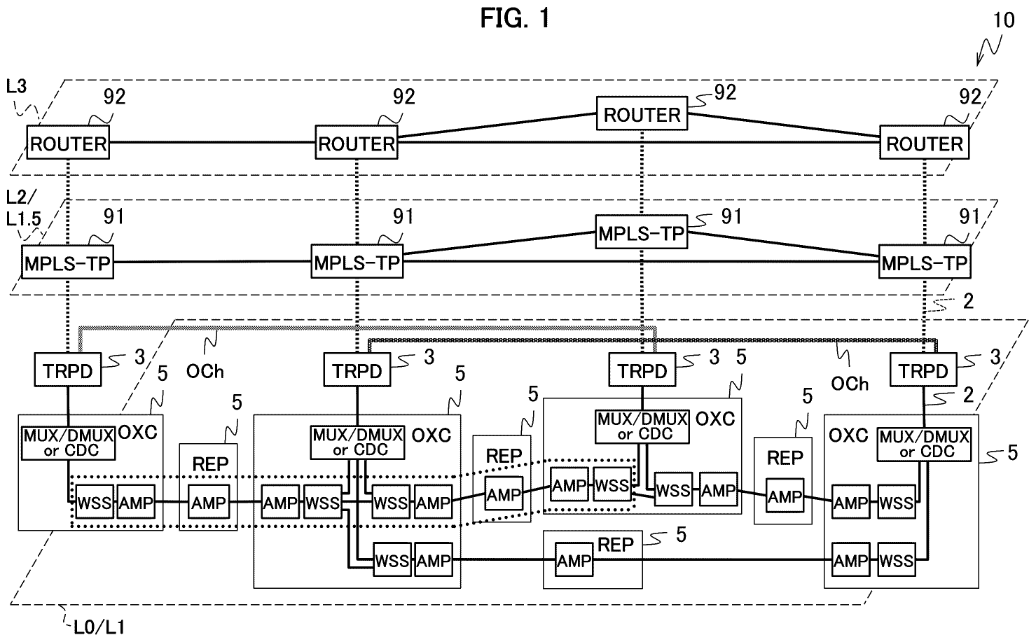

A configuration of an optical transmission system will be described with reference to FIG. 1. FIG. 1 is a configuration diagram of an optical transmission system 10. The optical transmission system 10 is hierarchized into, in order from the lower layer, an L0/L1 network, an L2/L1.5 network, an L3 network, and a service network (not illustrated) and includes a group of devices deployed for each network and optical transmission lines 2 connecting them each other. A node (device) deployed within the L0/L1 network, which is the lower layer, is, for example, an optical cross connect (OXC), a repeater (relay device, Repeater: REP), or a transponder (TRPD) device. In FIG. 1, transponder devices are denoted with the reference signs “3”, and OXCs and REPs are denoted with the reference signs “5”. An OXC incorporates an optical multiplexer/demultiplexer (MUX/DMUX), a wavelength selective switch(es) (WSS), and an optical amplifier(s) (Amplifier: AMP). Alternatively, an OXC may incorporate a colorless directionless contentionless (CDC) device instead of the MUX/DMUX. An REP incorporates an optical amplifier. An optical channel (OCh) of each wavelength is formed between transponder devices. A node deployed within the L2/L1.5 network is, for example, a multi-protocol label switching-transport profile (MPLS-TP) device 91 and is connected to a TRPD of the L0/L1 network. A node 92 deployed within the L3 network is, for example, a router. A node deployed within the service network is, for example, a server. The present invention identifies a failure in an L0/L1 network, which is a lower layer of an optical transmission system, at the level of the nodes or further at the level of the devices in a node. The present invention first extracts a component that is likely to include a failure location at the level of a component including one or more nodes and then identifies the failure location in the extracted component.

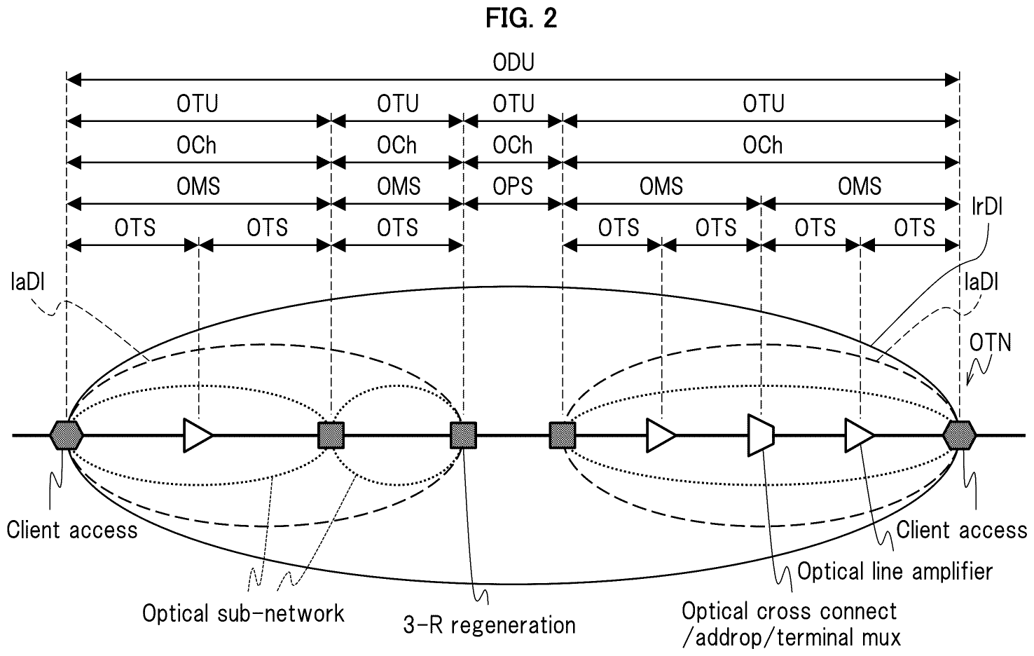

Setting of the component will be described with reference to FIG. 2. As illustrated in FIG. 2, the L0/L1 network is further hierarchized into, in order from the lower layer, optical transmission sections (OTSs), optical multiplex sections (OMSs) and optical physical sections (OPSs), optical channels (OChs), optical transport units (OTUs), and an optical-channel data units (ODUs). An OMS represents a logical communication path (path/connection) of a wavelength-multiplexed optical signal (corresponding to a plurality of OChs) and is terminated every time the wavelength-multiplexed signal is multiplexed/demultiplexed in an OXC node or an Add/Drop node. Therefore, by setting an OMS as a component, it is possible to identify the failure location at the level of components with relatively high accuracy (see Patent Literature 2).

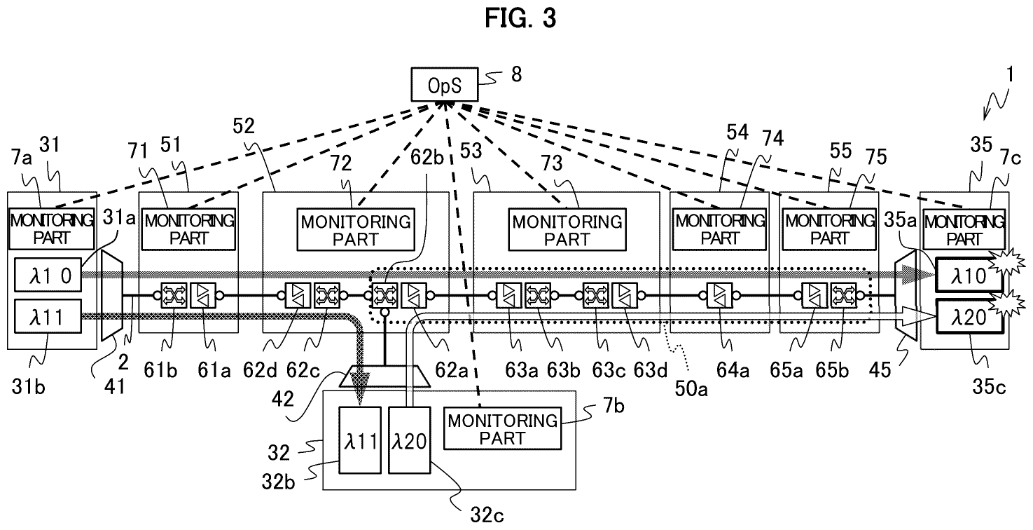

The optical transmission system according to the present embodiment will be described with reference to FIG. 3. FIG. 3 is a diagram illustrating a configuration of an optical transmission system corresponding to a portion of the L0/L1 network. FIG. 3 illustrates, in a simplified manner, a component (failure-suspected component) estimated to include a failure location, and a portion related to the extraction thereof. Specifically, in the optical transmission system 1 illustrated in FIG. 3, transponder devices 31, 32, and 35, optical multiplexers/demultiplexers 41, 42, and 45, and nodes 51, 52, 53, 54, and 55 are arranged and connected to each other via the optical transmission lines 2. In FIG. 3, the left represents a transmission side (upstream) and the right represents a reception side (downstream). The optical transmission system 1 according to the present embodiment further includes monitoring parts (monitoring means) 7a, 7b, 7c, and 71 to 75 that are provided in the transponder devices 31, 32, and 35 and the nodes 51 to 55 and perform performance monitoring (PM) collection, and an operation system (OpS, control means) 8 that controls the monitoring parts 7a, 7b, 7c, and 71 to 75. Further, in FIG. 3, the optical transmission system 1 includes logical optical paths (represented by the thick arrows in FIG. 3) of optical channels λ10, λ11, and λ20. Note that the optical channels are represented by being numbered λ01, λ02, λ03, . . . in order of the wavelength.

The transponder devices 31, 32, and 35 incorporate necessary ones among transponders for respective optical channels. In the case of FIG. 3, the transponder device 31 incorporates transponders 31a and 31b of λ10 and λ11, the transponder device 32 incorporates transponders 32b and 32c of λ11 and λ20, and the transponder device 35 incorporates transponders 35a and 35c of λ10 and λ20. The transponder devices 31, 32, and 35 are referred to as a transponder device(s) 3 as appropriate in cases where they are not distinguished.

The nodes 51, 52, and 55 constitute OXCs together with the optical multiplexers/demultiplexers 41, 42, and 45. The node 53 is also a part of an OXC, and illustration of the optical multiplexer/demultiplexer is omitted in FIG. 3. Each of the nodes 51, 52, 53, and 55 incorporates a WSS and an optical amplifier. The node 54 is an REP and incorporates an optical amplifier 64a. The nodes 51 to 55 further incorporate a power source, a fan (cooling means), and the like. In addition, the optical amplifiers of the nodes 51 to 55 are of the automatic gain control (AGC) type. The nodes 51, 52, 53, 54, and 55 are referred to as a node(s) 5 as appropriate in cases where they are not distinguished.

The monitoring parts 7a, 7b, and 7c collect the signal qualities in time series from the reception ends of the optical paths in the transponder devices 31, 32, and 35 to detect deterioration in the signal qualities.

In the nodes 51, 52, 53, 54, and 55, the monitoring parts 71, 72, 73, 74, and 75 (referred to as a monitoring part(s) 7 as appropriate in cases where they are not distinguished) each collect optical signal power (transmission power and reception power) in time series from each of the transmission end and the reception end of the corresponding node 5 and/or points at or between the devices in the corresponding node 5, i.e., the transmission end and the reception end of each device, and stores the collected optical signal power for a predetermined period. Then, under the control of the OpS 8, they each determine whether there is an abnormality of the temporal change of the accumulated signal output, i.e., the signal output collected immediately before. The storage period of the signal data is set to be equal to or longer than the time required to determine normality/abnormality of the temporal change, and it is possible to reduce the load of the optical transmission system 10 by decreasing the amount of accumulated data as the storage period is shorter.

In addition, in order for the monitoring part 7 to collect the signal output, the node 5 includes photodiodes (PD, not illustrated) at the transmission end and the reception end thereof and at point(s) (referred to as a signal collection terminal(s) (signal collection point(s)) p in cases where they are not distinguished) at or between devices in the node 5. In FIG. 3, the signal collection terminals p is represented by white circles “◯”. Although the number of the signal collection terminals p in each node 5 is not particularly defined, it is preferable to provide a signal collection terminals p at least at the reception end, and it is more preferable to provide the signal collection terminals p at both the transmission end and the reception end. Furthermore, depending on the constituent components (devices) of the node 5 and the number of the devices, it is preferable to provide the signal collection terminal(s) p also at or between the devices.

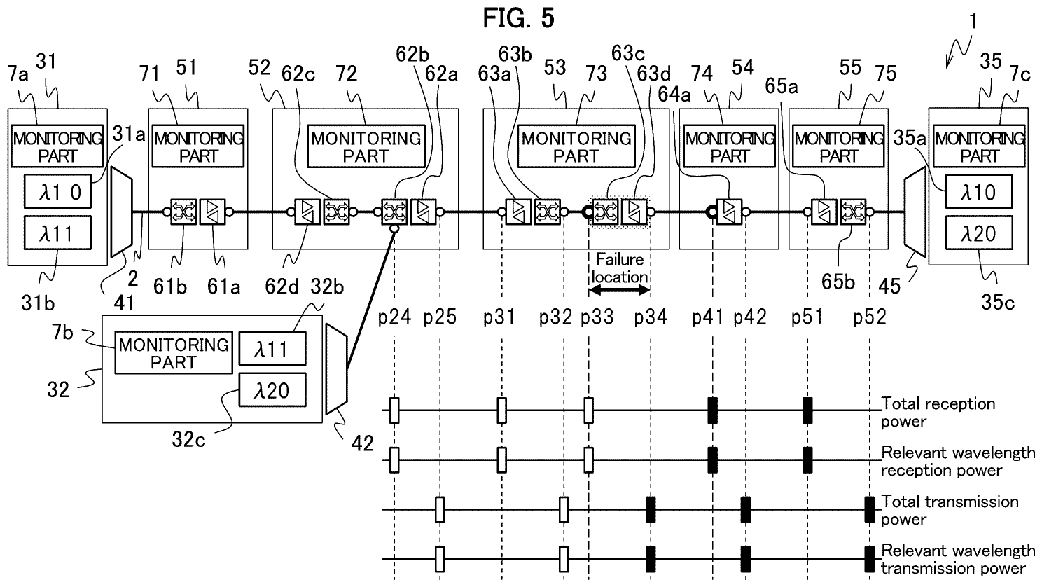

The node 54, an REP including the optical amplifier 64a having a high failure location identification priority, sets both sides of the optical amplifier 64a, i.e., the transmission end and the reception end of the optical amplifier 64a, as signal collection terminals p41 and p42 (see FIG. 5). In addition, the nodes 51 and 55, each including one WSS also having a high failure location identification priority and one optical amplifier which are connected in series, each set their transmission end and reception end as signal collection terminals p. The nodes 52 and 53 are each provided with signal collection terminals p on both sides of a set in which one WSS and one optical amplifier are connected in series. The node 52 is further provided with signal collection terminals p at two branched outputs of the WSS 62b. As described above, in the nodes 5, a signal collection terminal p is provided at at least one of the transmission side and the reception side of each of the WSS and the optical amplifier having high priorities. Note that the signal collection terminals p are denoted with pll and p12 in the node 51: p21, p22, p23, . . . in the node 52: and p31, p32, p33, . . . in the node 53 (see FIG. 5).

The OpS 8 makes connections to the monitoring parts 7a, 7b, 7c, and 71 to 75 via data communication networks to control them. The OpS 8 extracts a component (failure-suspected component) that is likely to include a failure location in optical path(s) in which the monitoring parts 7a, 7b, and 7c have detected deterioration of signal quality. In addition, the OpS 8 causes the monitoring parts 7 provided in the nodes 5 included in the failure-suspected component to determine an abnormality based on the accumulated signal output, to identify a failure location in the failure-suspected component.

### [Failure Location Identification Process]

In the optical transmission system according to the present invention, the monitoring parts 7a, 7b, 7c, and 7 collect signal information in time series from the reception ends or the like of the transponder devices 3 and the nodes 5, for which the monitoring parts 7a, 7b, 7c, and 7 are provided. In parallel, the OpS 8 performs a failure-suspected component extraction process of extracting a component (failure-suspected component) estimated to include a failure location and further performs a failure location identification process of identifying the failure location in the failure-suspected component.

### (Failure Location Identification Method)

A failure location identification method according to the present invention performs, by the monitoring parts 7a, 7b, 7c, and 7: a collection step of collecting signal information in time series from the reception ends of the transponder devices 3 and the nodes 5, for which the monitoring parts 7a, 7b, 7c, and 7 are provided: and, in parallel with the collection step, a failure-suspected component extraction step of extracting a component (failure-suspected component) estimated to include a failure location and a failure location identification step of identifying a failure location in the failure-suspected component.

The monitoring parts 7a, 7b, 7c, and 7 collect signal information from the reception ends or the like of the transponder devices 3 and nodes 5, for which the monitoring parts 7a, 7b, 7c, and 7 are provided, every predetermined time tl. The monitoring parts 7a, 7b, and 7c collect signal qualities from the reception ends of the transponder devices 31, 32, and 35. The monitoring parts 7 collect optical signal power from the signal collection terminals p of the nodes 5. The storage time granularity of the information collected by the monitoring parts 7a, 7b, 7c, and 7 and OpS 8 therethrough is preferably shorter (higher) in order to improve the accuracy of identifying the failure location in the failure location identification process. Specifically, the storage time granularity is preferably 1 minute interval or less (t1≤1 min), and more preferably several seconds to several tens of seconds (less than 60 seconds).

The OpS 8 causes the monitoring parts 7a, 7b, and 7c to detect deterioration of the collected signal qualities every predetermined time t2 (t2≥t1). Specifically, upon detection of an abnormality or a change in the time-series data of a pre-forward error correction bit error rate (Pre-FEC BER) of the transponder devices 31, 32, and 35 to be monitored, the monitoring parts 7a, 7b, and 7c identify the deterioration mode based on a correlation analysis between the time-series data of the Pre-FEC BER and time-series data of analog information regarding the optical physical characteristics monitored by a digital signal processor (DSP) (see Patent Literature 2). An abnormality in the time-series data of the Pre-FEC BER indicates that the quality of the signal flowing through a logical optical path is deteriorated. Hereinafter, the analog information regarding the optical physical characteristics is referred to as digital signal processing based optical performance monitoring (DSP-based OPM).

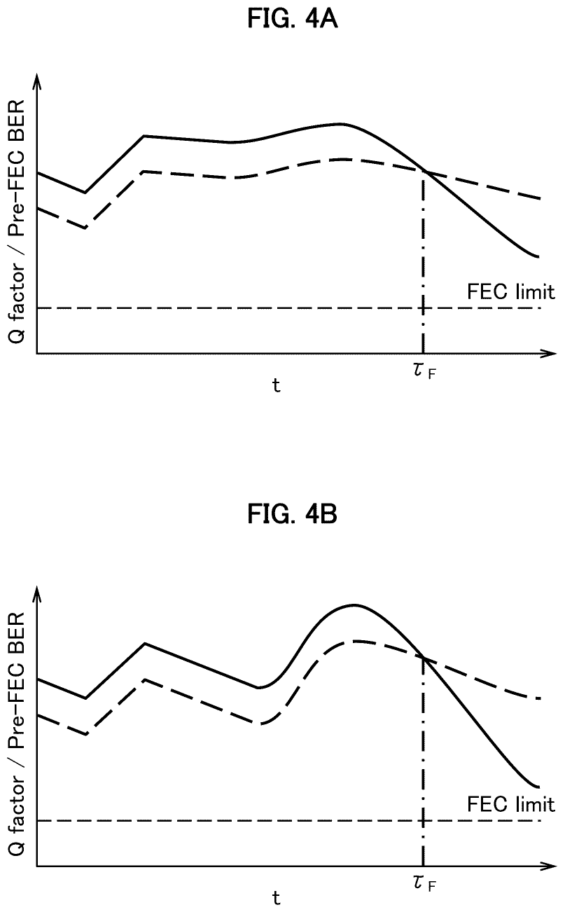

With such method, as illustrated in FIGS. 4A and 4B, it is possible to determine whether the signal quality (indicated by the solid line in FIGS. 4A and 4B) has deteriorated to fall below a threshold value (indicated by a dashed line in FIGS. 4A and 4B) before reaching a forward error correction (FEC) limit, which is a limit value where a signal error will be introduced, thereby to achieve early detection. In this case, the monitoring part 7c has detected, from the transponder device 35, deterioration in the signal qualities of the wavelengths of λ10 (FIG. 4A) and λ20 (FIG. 4B). Therefore, it is likely that the component 50a (the range surrounded by the dotted line in FIG. 3), which is from the WSS 62b of the node 52 to the node 55 located downstream and constitutes a common optical path of λ10 and λ20 with the transponder device 35 being the reception end, includes a failure location. In view of this, the OpS 8 extracts the component 50a as a failure-suspected component.

The time granularity of the failure-suspected component extraction process is, for example, an interval of 15 minutes (t2=15 min), and is preferably shorter for early detection of a failure, but on the other hand the processing by the OpS 8 would get tough. Alternatively, the monitoring parts 7a, 7b, and 7c may check deterioration of the signal qualities with a time granularity shorter than 15 minutes and notify the OpS 8 of detection of the deterioration in the signal quality thereby to start the failure-suspected component extraction process.

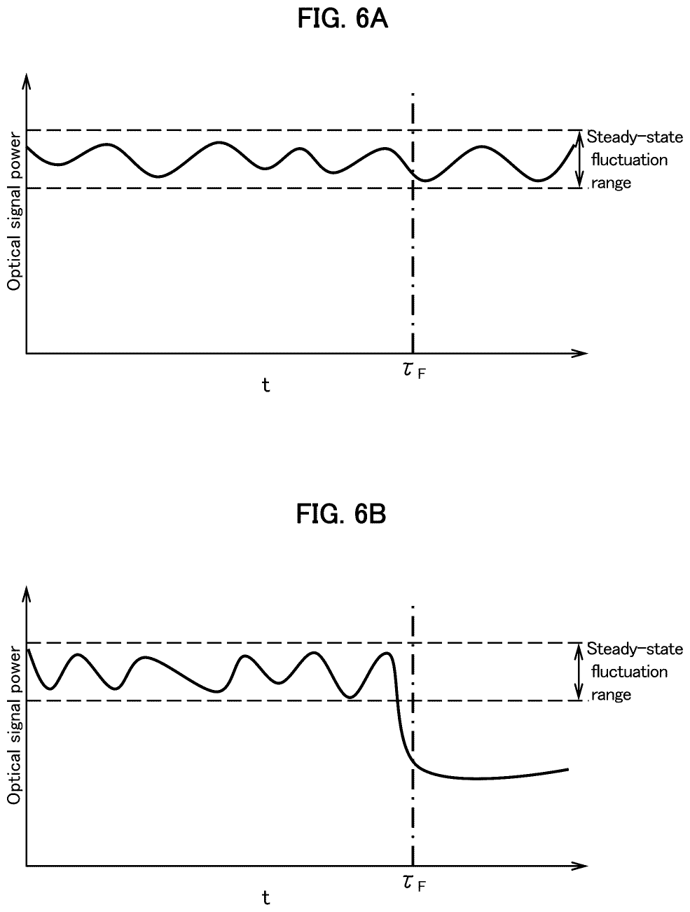

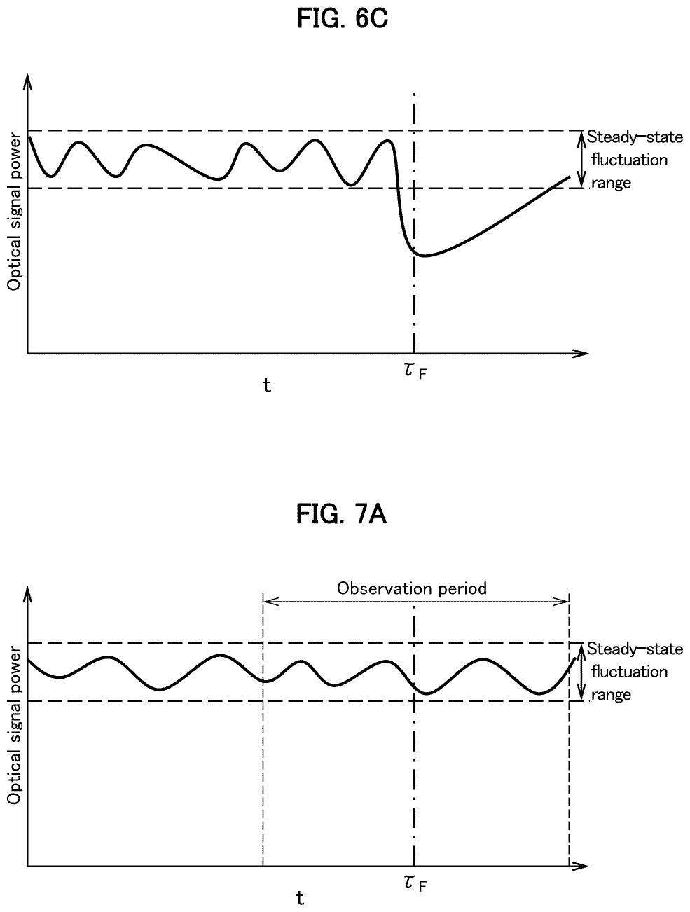

When the failure-suspected component 50a is extracted by the failure-suspected component extraction process, the OpS 8 performs the failure location identification process to identify the failure location (failure portion) from the nodes 5 (52, 53, 54, and 55) and the optical transmission lines 2 included in this failure-suspected component 50a. The OpS 8 determines whether the temporal change in the optical signal power (reception power, transmission power) of the wavelengths λ10 and λ20, accumulated in the monitoring parts 72, 73, 74, and 75, is normal or abnormal at and around the abnormality detection time point τ_{F} (see FIGS. 4A and 4B) detected in the failure-suspected component extraction process, in order from the signal collection terminal p52 on the downstream side. If the signal is normal, the temporal fluctuation of the optical signal power falls within a steady-state fluctuation range as illustrated in FIG. 6A. If the signal quality has deteriorated, as illustrated in FIG. 6B, the optical signal power fluctuates below the steady-state fluctuation range at the abnormality detection time point τ_{F}. In the case of FIG. 5, the reception power is abnormal (represented by a black quadrangle) up to the transmission end p41 of the node 54 and is normal (represented by a white quadrangle) at the relay point p33 of the node 53 and upstream thereof. On the other hand, the transmission power is abnormal up to the reception end p34 of the node 53 and is normal at the relay point p32 of the node 53 and upstream thereof. Therefore, a section (represented by the double-headed arrow in the drawing) between the signal collection terminals p33 and p34 is identified as a failure location, and thus it is understood that either or both of the WSS 63c and the optical amplifier 63d of the node 53 have failed.

Note that it is likely that a failure of an optical amplifier would exert influence upon all the wavelengths in the form of power fluctuation. On the other hand, a failure of a WSS may appear as an abnormality that affects only one wavelength, and it is thus possible to clearly determine an abnormality by observing the temporal change in the optical signal power of each wavelength of λ10 and λ20 rather than the total optical signal power of all the wavelengths.

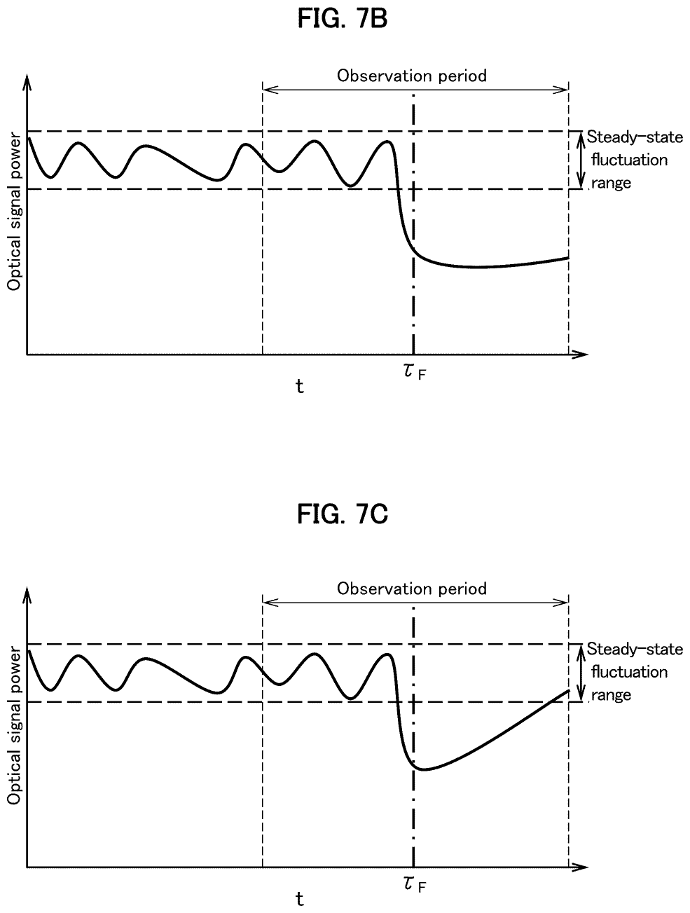

As illustrated in FIGS. 7A and 7B, the temporal change in the optical signal power is preferably determined in a predetermined period before and after the abnormality detection time point τ_{F}. By setting the predetermined period short to a degree where the determination is possible, it is possible to reduce the load of the processing. Specifically, it is preferable to perform the determination based on the temporal changes in a plurality of times of data over the predetermined period. For example, when t1=10 sec and the predetermined period is 15 minutes, the determination can be performed based on temporal changes in 90 times of data. In addition, as the monitoring parts 7 and OpS 8 are to store the signal data up to the predetermined period, it is possible to reduce the load of data storage. Note that old signal data that has expired the storage period of storage by the monitoring part 7 and OpS 8 or signal data collected from the signal collection terminals p outside the failure-suspected component 50a may be stored after being converted into statistical information by the OpS 8, for example.

In addition, it is possible to reduce erroneous determination by performing abnormality determination using the fluctuation range in the predetermined period other than (before) the abnormality detection time point τ_{F} as a reference. In addition, it is possible to check a transient change caused when the optical amplifier or WSS on the upstream side of the signal collection terminal p is controlled. For example, a case where the decrease in the optical signal power cannot be observed due to the optical amplifier performing ALC control or the like on the decrease in the optical signal power is conceived of. FIGS. 6C and 7C illustrate examples of temporal changes in the optical signal power by the ALC control. Furthermore, the fluctuation range used as a criterion for the determination is preferably the fluctuation range outside (before) the predetermined period for determining the temporal change before and after the abnormality detection time point τ_{F}.

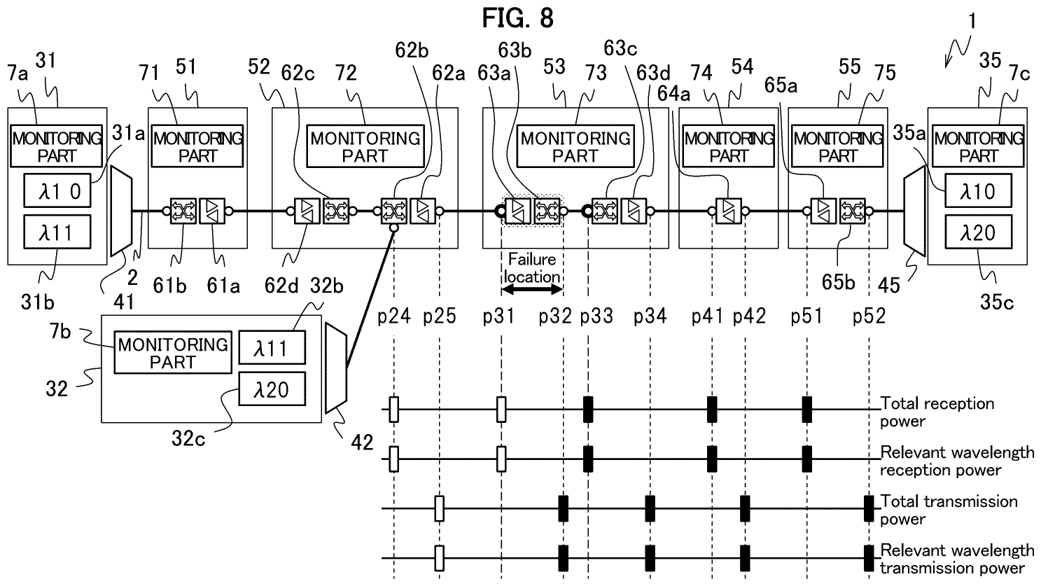

FIG. 8 illustrates a state of the temporal change in the optical signal power in a case where, of the same node 53 as in FIG. 5, either or both of another WSS 63b and another optical amplifier 63a have failed. Like this, depending on the configuration of the node 5, signal collection terminals p are provided not only at the transmission end and the reception end but also at a relay point, whereby it is possible to identify a failure location with high accuracy.

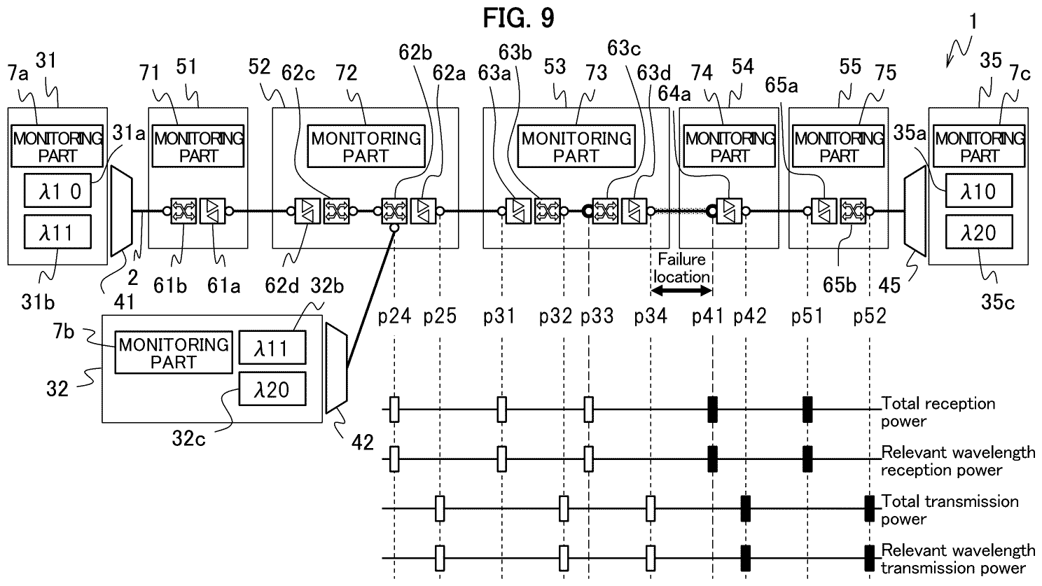

FIG. 9 illustrates a state of the temporal change in the optical signal power in a case where the optical transmission line 2 connecting the nodes 53 and 54 has failed. Like this, by providing the signal collection terminals p at the transmission end and the reception end of the node 5, it is possible to identify a failure location on the node 5 or the optical transmission line 2.

### (Modification Examples)

It is preferable that in the optical system according to the present invention, the monitoring part(s) 7 have an optical spectrum analysis function. By collecting the spectra of the optical signal together with the optical signal power from the signal collection terminals p of the nodes 5, the monitoring parts 7 can identify a failure location which is difficult to be identified only with the optical signal power and can identify the failure location with higher accuracy.

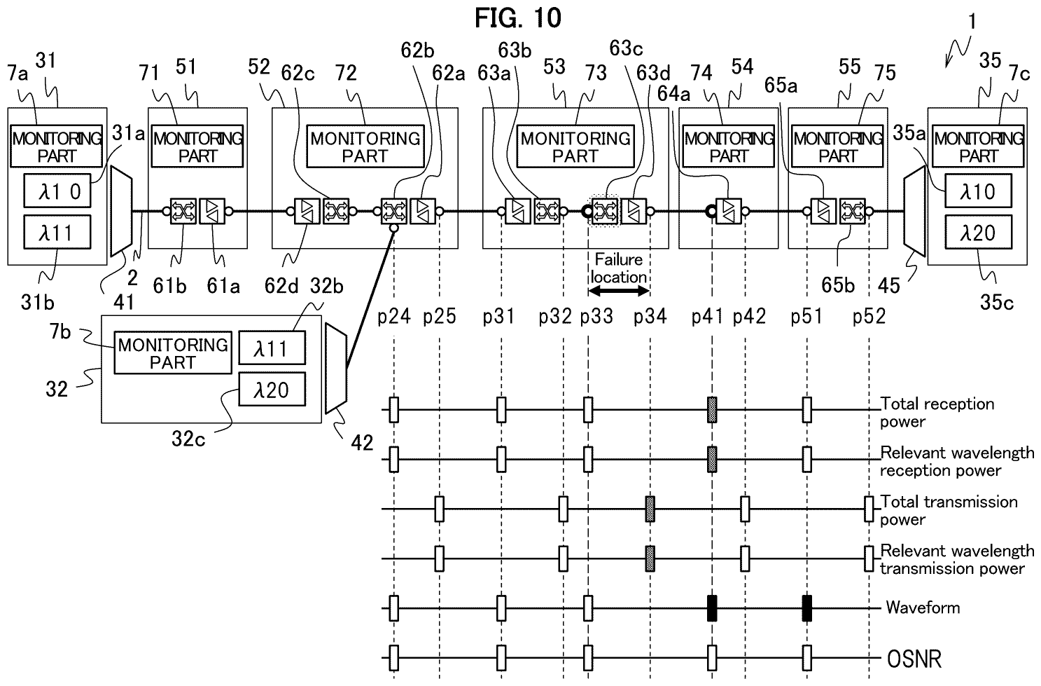

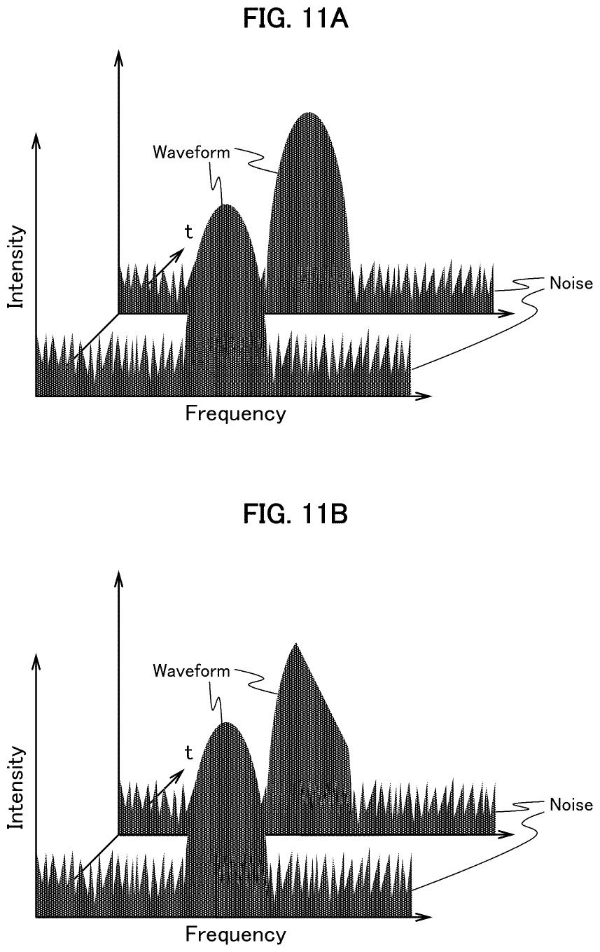

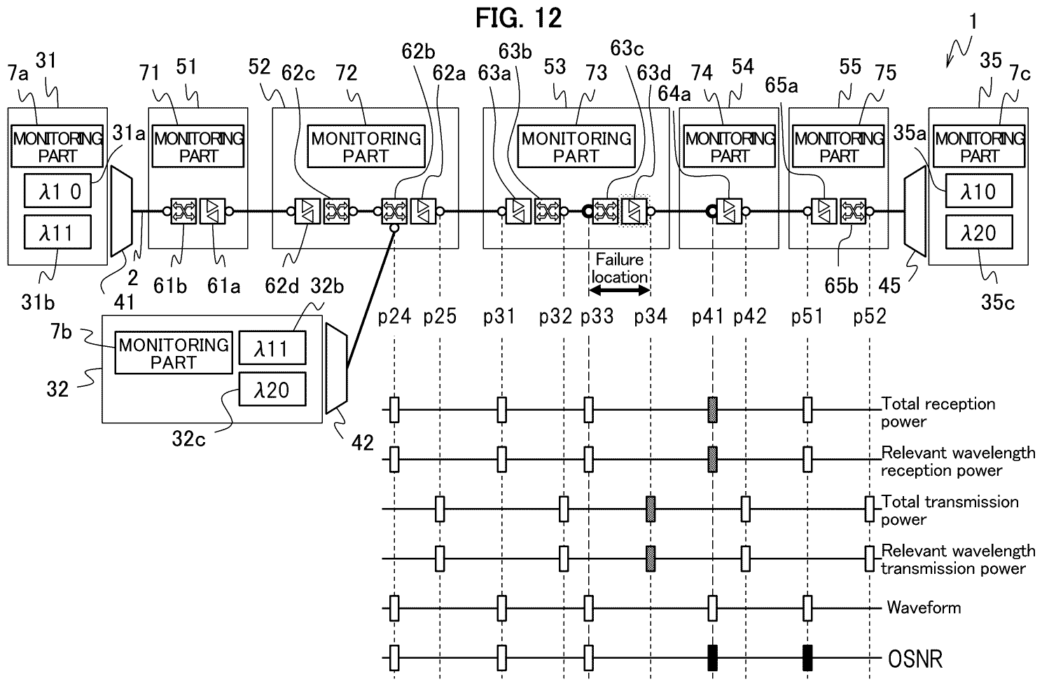

As illustrated in FIG. 10, the failure location identification process determines whether the temporal change is normal or abnormal also with regard to the waveform and the optical signal-to-noise ratio (OSNR) together with the optical reception power. When the optical amplifiers on the downstream side of the failure location are of the AGC type as described above, as illustrated in FIGS. 5, 8, and 9, abnormalities in the temporal change in the optical signal power continually occurs in the signal on the downstream side of the failure location. However, when the optical amplifiers on the downstream side of the failure location are of the automatic level control (ALC) type, the decrease in the optical signal power on the downstream side of the failure location is temporary; and thus it may be impossible (indicated by quadrangles each with a dotted pattern) to confirm an abnormality of the temporal change in the optical signal power even in the vicinity of the failure location. FIG. 10 illustrates a case where the optical amplifiers of the nodes 5 are of the ALC type and a filter abnormality occurs in the WSS 63c of the node 53. With this, a minute amount of power fluctuation may occur but it is difficult to determine an abnormality of the temporal change in the optical signal power. On the other hand, regarding the optical spectrum, in the case of a normal signal, the temporal change in the shape of the signal waveform including the wavelengths of λ10 and λ20 is small (falls within a steady-state fluctuation range) as illustrated in FIG. 11A; and in the case of an abnormal signal, the shape of the signal waveform is deformed at the abnormality detection time point IF (see FIGS. 4A and 4B) as illustrated in FIG. 11B.

In the case illustrated in FIG. 10, the waveform is abnormal up to the transmission end p41 of the node 54 and is normal at the relay point p33 of the node 53 and upstream thereof. On the other hand, regarding the optical signal power, an abnormality may possibly be detected only in the reception power at the transmission end p41 of the node 54 and in the transmission power at the reception end p34 of the node 53. Note that it is likely that no abnormality is detected in the OSNR. When an abnormality is detected in the optical signal power as described above, the failure location is easily identified as being between the signal collection terminals p33 and p34. However, even if an abnormality is not detected in the temporal change in the optical signal power, in other words, an abnormality is not detected in the temporal change in the optical signal power or is detected only at the signal collection terminals p34 and p41, whereby the WSS 63c, which is the only WSS located between the signal collection terminals p33 and p41, at which an abnormality/normality of the temporal change in the waveform is determinable, is identified as the failure location. Even if an abnormality is detected in the OSNR, when an abnormality in the waveform is detected, the WSS is identified as the failure location in the similar manner.

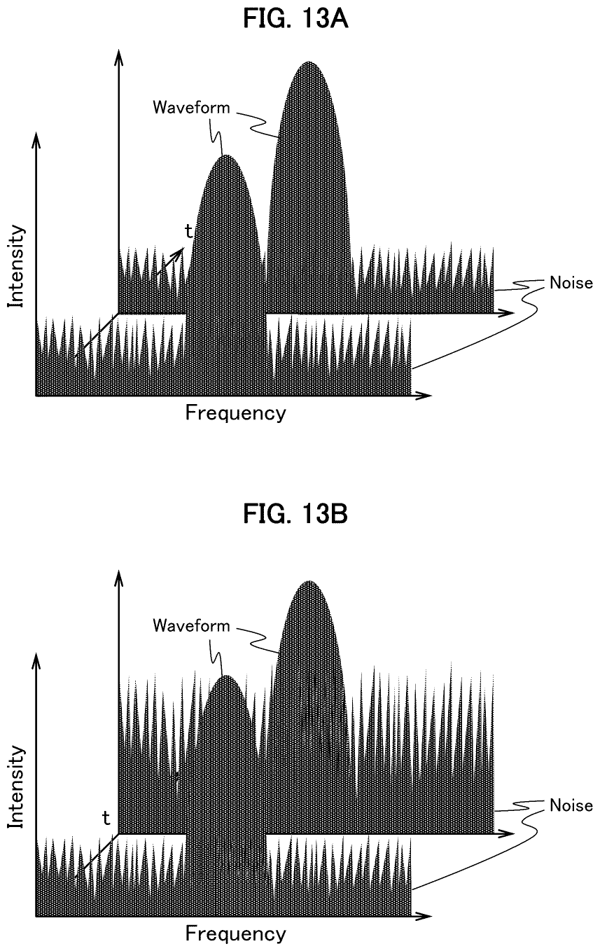

FIG. 12 illustrates a case where the optical amplifiers of the nodes 5 are of the ALC type as in FIG. 10 and a noise abnormality occurs in the optical amplifier 63d of the node 53. Due to this, an instantaneous power fluctuation may occur when a reduction in the amplification temporarily exudes, but it is difficult to determine an abnormality of temporal change in the optical signal power. On the other hand, regarding the optical spectrum, in the case of a normal signal, the temporal change in the noise (OSNR) generated in the signal waveform including wavelengths of λ10 and λ20 is small (falls within a steady-state fluctuation range) as illustrated in FIG. 13A; and in the case of an abnormal signal, the deterioration in the OSNR increases at the abnormality detection time point TF (see FIGS. 4A and 4B) as illustrated in FIG. 13B.

In the case of FIG. 12, the OSNR is abnormal up to the transmission end p41 of the node 54, and is normal at the relay point p33 of the node 53 and upstream thereof. On the other hand, regarding the optical signal power, an abnormality may possibly be detected only in the reception power of the transmission end p41 of the node 54 and in the transmission power of the reception end p34 of the node 53. Note that no abnormality is detected in the waveform. When an abnormality is detected in the optical signal power as described above, the failure location is easily identified as being between the signal collection terminals p33 and p34. However, even if an abnormality is not detected in the temporal change in the optical signal power, in other words, an abnormality is not detected in the temporal change in the optical signal power or is detected only at the signal collection terminals p34 and p41, whereby the optical amplifier 63d, which is the only optical amplifier located between the signal collection terminals p33 and p41, at which an abnormality/normality of the temporal change in the OSNR is determinable, is identified as the failure location.

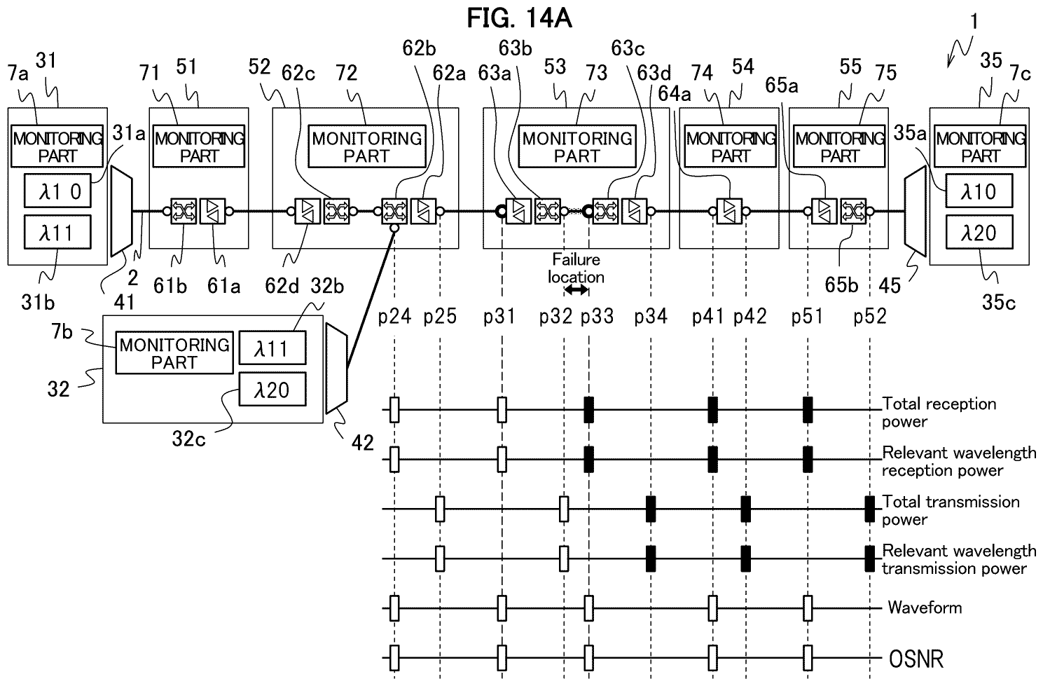

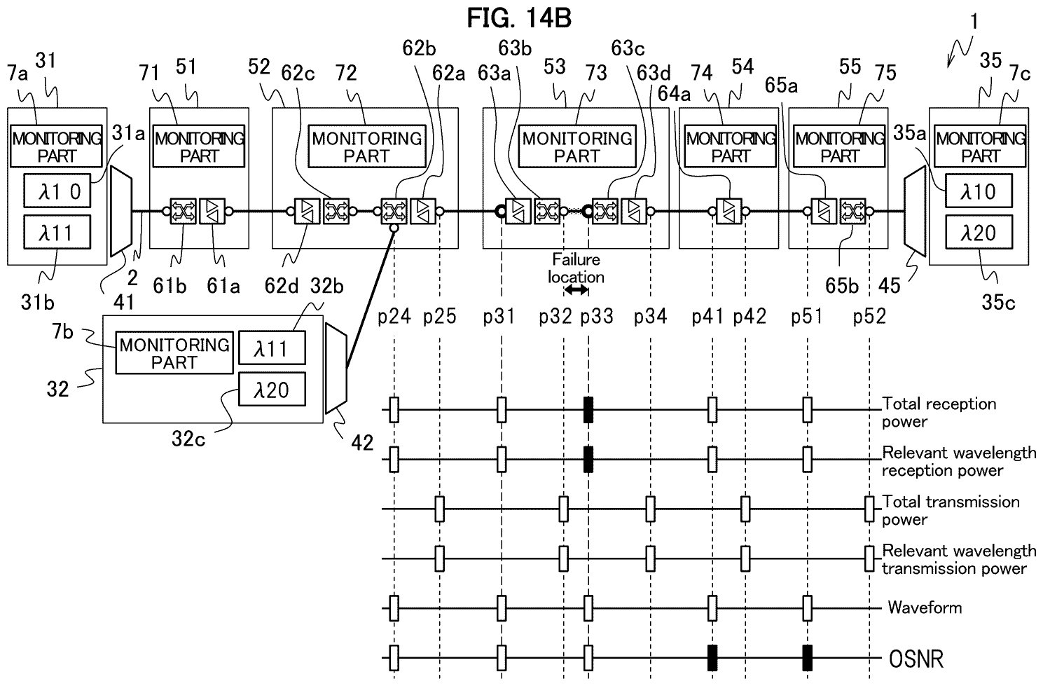

FIG. 14A illustrates a state of temporal changes in the optical signal power, the waveform, and the OSNR in a case where an optical fiber in the node 53 has failed. In the case of FIG. 14A, optical amplifiers of the nodes 5 are of the AGC type. Therefore, similarly to FIG. 9, the abnormality/normality of the temporal change in the optical signal power is determinable between the signal collection terminals p32 and p33 on the transmission side and the reception side of the optical fiber being the failure location. On the other hand, if the optical amplifiers on the downstream side of the failure location are of the AGC type, no abnormality is detected in the temporal change in the waveform and OSNR.

Similarly to FIG. 14A, FIG. 14B illustrates a state of temporal changes in the optical signal power, the waveform, and the OSNR in a case where an optical fiber in the node 53 has failed. However, in FIG. 14B, the optical amplifiers of the nodes 5 are of the ALC type. In this case, the abnormality of the temporal change in the optical signal power is detected only at the signal collection terminal p33 in the vicinity of the reception side (downstream side) of the optical fiber, which is the failure location. On the other hand, if the optical amplifiers on the downstream side of the failure location are of the ALC type, an abnormality is detected in the temporal change in the OSNR due to the power decrease in the failed optical fiber, at the signal collection terminal p41 and downstream thereof located downstream of the optical amplifier 63d, which is the first optical amplifier on the downstream side of the failed optical fiber. Note that no abnormality is detected in the temporal change in the waveform.

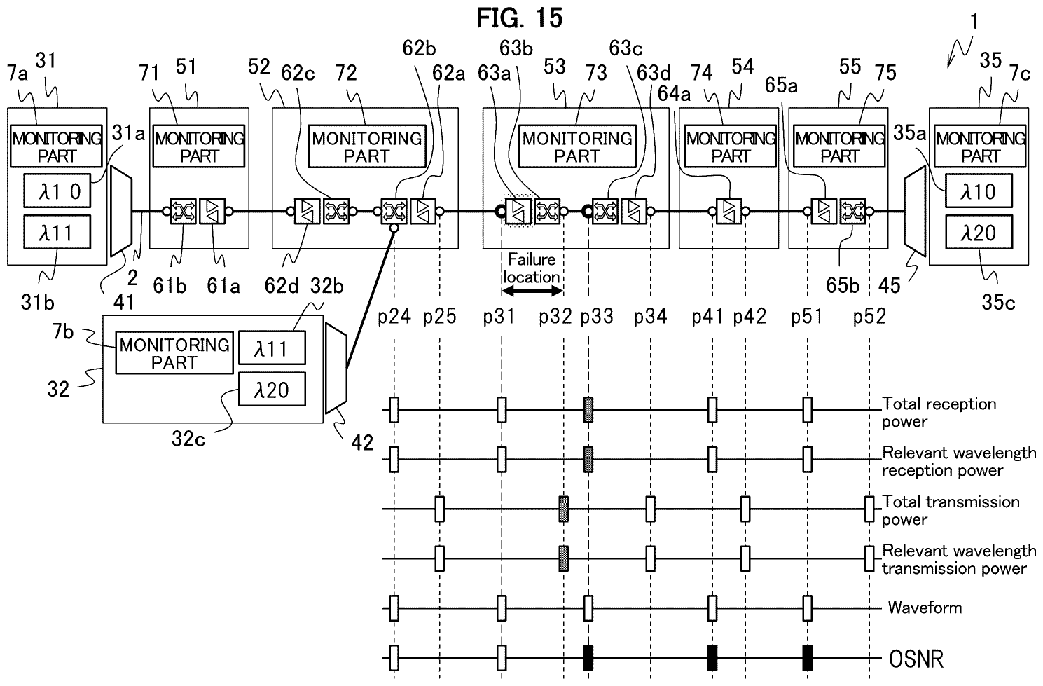

Similarly to FIG. 12, FIG. 15 illustrates a case where a noise abnormality has occurred in an optical amplifier in the node 53. However, the abnormality has occurred in the optical amplifier 63a, which is on the upstream side. When a reduction in the amplification by the optical amplifier 63a temporarily exudes and the WSS 63b located downstream of the optical amplifier 63a fails to adjust the attenuation amount or has a control lag, an instantaneous power fluctuation occurs. As a result, in a case where the optical amplifier 63a is of the AGC type, an abnormality of the temporal change in the optical signal power is detected only at the signal collection terminals p32 and p33 in the vicinity of the downstream side of the WSS 63b. Furthermore, an abnormality of the temporal change in the OSNR is detected at the signal collection terminal p33 and downstream thereof. On the other hand, when the optical amplifier 63a is of the ALC type, no abnormality is detected in the temporal change in the optical signal power.

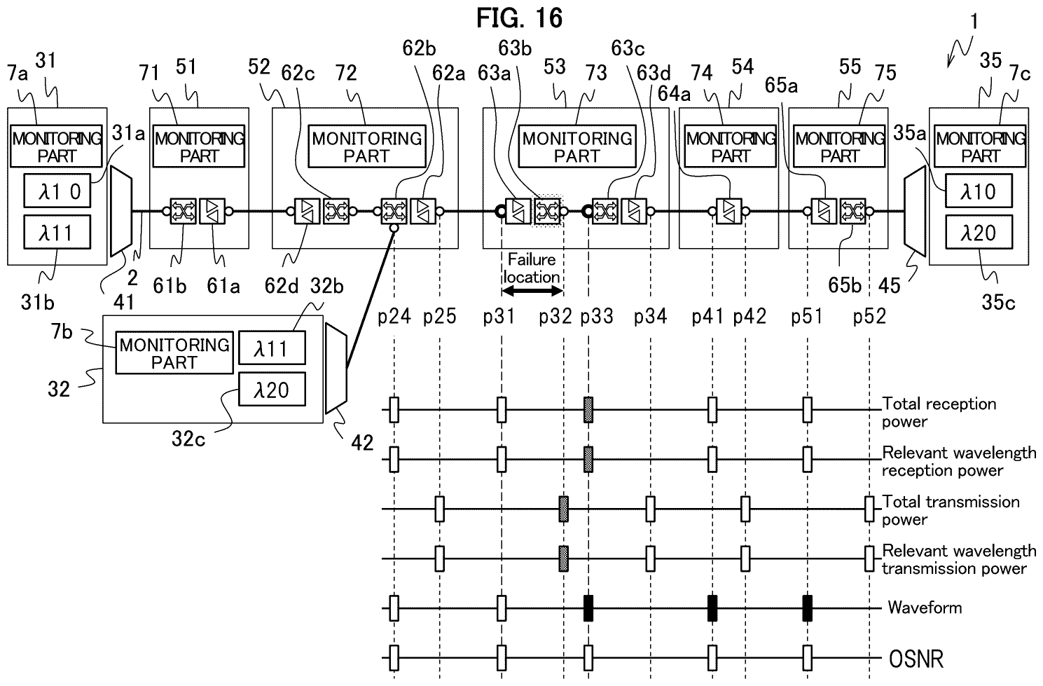

FIG. 16 illustrates a case where a filter abnormality has occurred in a WSS in the node 53 as in FIG. 10. However, the abnormality has occurred in the WSS 63b, which is on the upstream side. In a case where a minute amount of power fluctuation does not occur due to the attenuation amount adjustment by the WSS 63b, the abnormality of the temporal change in the optical signal power is not detected even at the signal collection terminals p32 and p33 in the vicinity of the downstream side of the WSS 63b. On the other hand, as in FIG. 10, an abnormality of the temporal change in the waveform is detected at the signal collection terminal p33 and downstream thereof on the downstream side of the WSS 63b.

As described above, by observing the temporal change in the optical signal power or further observing the temporal change in the waveform and OSNR, it is possible to identify the failure location from the failure-suspected component 50a. Note that, here, the temporal change in the optical signal power or the like of the signal collection terminals p is observed in order from the downstream side of the failure-suspected component 50a, but may be observed from the upstream side, or may be observed at two or more locations in parallel at the same time.

Note that, in the failure-suspected component extraction process, a component including no failure location may be extracted as the failure-suspected component. For example, as illustrated in FIG. 3, as the deterioration in the signal qualities of the wavelengths of λ10 and λ20 is detected, the component 50a constituting the common optical path of λ10 and λ20 is extracted as the failure-suspected component. However, when identification of a failure location in this component 50a fails, that is, an abnormality of the temporal change in the optical signal power or the like is detected at all the signal collection terminals p of the component 50a, the failure location may be possibly included in the range from the node 51 to the WSS 62c of the node 52, located upstream of the component 50a and constituting an optical path of λ10. In view of this, this range is extracted as the second failure-suspected component, and the failure location identification process is executed. As described, in the failure-suspected component extraction process, first, a component sharing the most optical paths of the wavelength at which the deterioration of the signal quality is detected is extracted as the most suspicious failure-suspected component. Then, when the failure location identification process fails to identify the failure location, a component sharing second to the most optical paths is extracted as the second failure-suspected component. In this case, when an abnormality of the temporal change in the optical signal power or the like is detected at all the signal collection terminals p in the previous failure location identification process, the upstream side is extracted: and when no abnormality is detected, the downstream side is extracted.

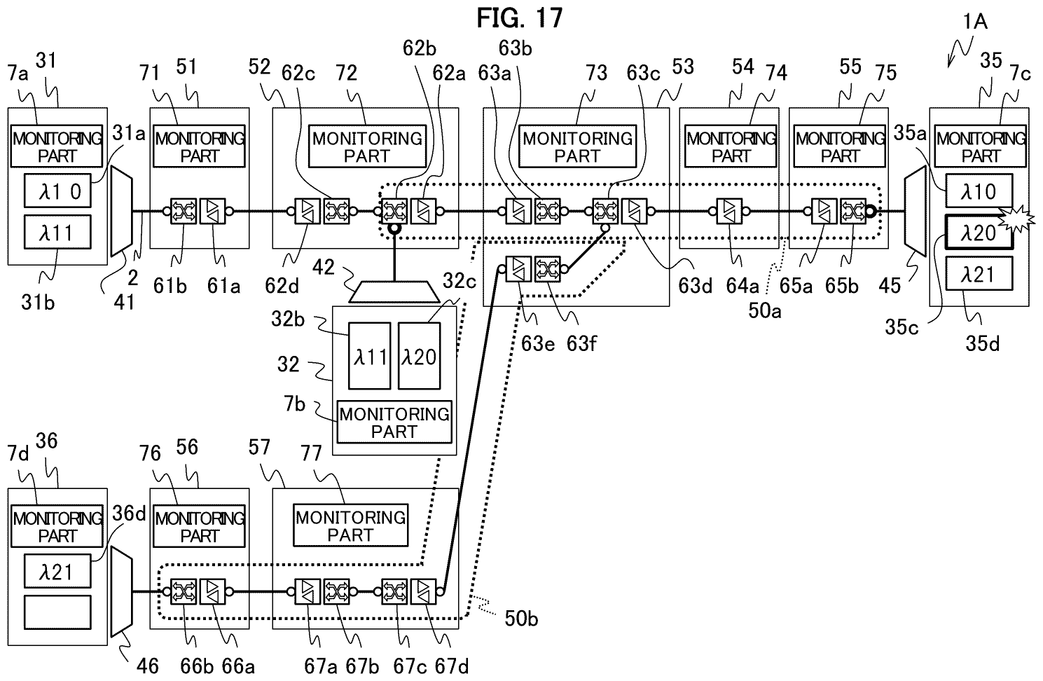

In addition, there is a case where deterioration in the signal quality is not detected at the wavelength of the optical path flowing through the failure location and deterioration in the signal quality is detected at an adjacent wavelength. Here, in the optical transmission system 1A illustrated in FIG. 17, a description will be given taking a case where the monitoring part 7c detects deterioration in the signal quality of the wavelength of λ20 in the transponder device 35 as an example. When identification of the failure location from the component 50a constituting the optical path of λ20 has failed, even when deterioration in the signal quality of the wavelength λ21 adjacent to λ20 is not detected, the failure location may be possibly included in the component 50b constituting the optical path of this λ21. In view of this, the component 50b is extracted as the next failure-suspected component and the failure location identification process is performed. Such deterioration in the signal quality at an adjacent wavelength is detected, for example, when there is an increase in the power due to a failure of a WSS.

### [Effects]

Effects of the optical transmission system according to the present invention will be described below:

An optical transmission system 1 according to the present invention includes a plurality of nodes 3 and 5 connected to each other by optical transmission lines 2. The optical transmission system 1 includes: monitoring parts 7a, 7b, 7c, and 71 to 75 respectively provided in the nodes 3 and 5 and configured to collect signal information in time series at at least one signal collection terminal p of a transmission end and a reception end of the corresponding node and a location at or between devices in the corresponding node: and an OpS 8 configured to control the monitoring parts 7a, 7b, 7c, and 71 to 75. The OpS 8 is configured to perform: a failure-suspected component extraction process of causing the monitoring parts 7a, 7b, and 7c to observe signal information on a reception end of a component including one or more nodes 5 and optical transmission lines 2 between the nodes 5 to extract a component 50a estimated to include a failure location, and a failure location identification process of identifying the failure location in the extracted component 50a by causing the monitoring parts 72 to 75 to observe a temporal change of the signal information at the signal collection terminals p in the respective nodes 52 to 55 and to detect an abnormality of the temporal change of the signal information.

In this way, according to the optical transmission system 1 of the present invention, first, the failure location is narrowed down at the level of a component, and the failure location is identified with limiting to this failure-suspected component. It is thus possible to identify the failure location with high accuracy and to improve the expandability.

In addition, in the optical transmission system 1 according to the present invention, the monitoring parts 71 to 75 are configured to perform optical spectrum analysis to acquire a waveform and an optical signal-to-noise ratio of the collected signals, and, the Ops 8 is configured to, in the failure location identification process, identify the failure location by causing the monitoring parts 72 to 75 to detect the abnormality of the temporal change in at least one of: a signal output, a signal input, the waveform, and the optical signal-to-noise ratio.

As monitoring parts 71 to 75 have the optical spectrum analysis function as described, it is possible to identify the failure location which is difficult to be identified only with the optical signal power, and it is possible to identify the failure location with higher accuracy.

In addition, in the optical transmission system 1 according to the present invention, when the failure location is not identified from the failure-suspected component 50a by the failure location identification process, the OpS 8 performs the failure location identification process on another component other than the component 50a, the other component including at least one of: one or more optical transmission lines having a wavelength of a signal based on which the component 50a has been determined to include the failure location in the failure-suspected component extraction process: and an optical transmission line having a wavelength adjacent to the wavelength.

In this way; when the failure location identification process fails to identify a failure location, a failure-suspected component is extracted in order as a target of the failure location identification process and the failure location identification process is executed again. In this manner, it is possible to identify the failure location.

In addition, in the optical transmission system 1 according to the present invention, the monitoring parts 72 to 75 observe, in the failure location identification process, the temporal change of the signal information in a period of a predetermined length before and after an abnormality detection time point TF at which a signal based on which the component 50a has been determined to include the failure location has been collected.

In this way, by limiting the temporal change in the signal information to be short to a time slot in which the abnormality may possibly be detected, it is possible to reduce the load for the failure location identification process.

In addition, in the optical transmission system 1 according to the present invention, the monitoring parts 72 to 75 determine, in the failure location identification process, the abnormality of the temporal change of the signal information using, as a reference, the range of the temporal fluctuation in a period not including the abnormality detection time point τ_{F} at which the signal based on which the component 50a has been determined to include the failure location has been collected.

In this way, it is possible to reduce erroneous determination by determining whether the temporal change of the signal information is normal or abnormal using the fluctuation range in a steady state as a reference.

In addition, in the optical transmission system 1 according to the present invention, the OpS 8 performs the failure-suspected component extraction process with a time granularity of less than 15 minutes, and the monitoring parts 7a, 7b, 7c, and 71 to 75 collect the signal information at the signal collection terminals p with a time granularity equal to or shorter than the time granularity of the failure-suspected component extraction process.

In this way, by performing the collection of the signal information and the failure-suspected component extraction process in a short time cycle, it is possible to detect a failure early and to improve the accuracy of identifying the failure location in the failure location identification process.

Note that the present invention is not limited to the above-described embodiment, and many modifications can be made by those skilled in the art within the technical idea of the present invention.

### REFERENCE SIGNS LSIT

10 Optical transmission system

1, 1A Optical transmission system (LO/L1 Network)

2 Optical transmission line (optical fiber)

3, 31, 32, 35, 36 Transponder device

31a, 31b, 32b, 32c, 35a, 35c, 35d, 36d Transponder

41, 42, 45, 46 Optical multiplexer/demultiplexer

50a, 50b Failure-suspected component

5, 51, 52, 53, 54, 55, 56, 57 Node

7a, 7b, 7c Monitoring part (monitoring means)

7, 71, 72, 73, 74, 75, 76, 77 Monitoring part (monitoring means)

8 OpS (control means)

1. An optical transmission system including a plurality of nodes connected to each other by optical transmission lines, the optical transmission system comprising:
a plurality of monitoring parts respectively provided in the plurality of nodes and each configured to collect signal information in time series at at least one signal collection point of a transmission end of the respective node, a reception end of the respective node, and a location at or between devices in the respective node; and
an operation system configured to control the plurality of monitoring parts,
wherein the operation system is configured to perform:
a failure-suspected component extraction process of, for a component including one or more of the plurality of nodes and zero or more optical transmission lines between the one or more of the plurality of nodes, causing the one or more monitoring parts respectively provided in the one or more of the plurality of nodes to observe signal information on a reception end of the component to extract the component as a failure-suspected component estimated to include a failure location, and
a failure location identification process of identifying the failure location in the extracted failure-suspected component by causing each of the one or more monitoring parts in the extracted failure-suspected component to observe a temporal change of the signal information at the at least one signal collection point in the respective node to detect an abnormality of the temporal change of the signal information.

2. The optical transmission system according to claim 1,
wherein the plurality of monitoring parts are each further configured to perform optical spectrum analysis to acquire a waveform and an optical signal-to-noise ratio of a collected signal, and
wherein the operation system is further configured to, in the failure location identification process, identify the failure location by causing each of the one or more monitoring parts in the extracted failure-suspected component to detect the abnormality of the temporal change in at least one of: a signal output, a signal input, the waveform, and the optical signal-to-noise ratio.

3. The optical transmission system according to claim 1,
wherein the failure-suspected component estimated to include the failure location is a first failure-suspected component, and
wherein the operation system is further configured to, when the failure location is not identified from the first failure-suspected component by the failure location identification process, perform the failure location identification process on a second failure-suspected component other than the first failure-suspected component, the second failure-suspected component including at least one of: one or more optical transmission lines having a first wavelength of a signal based on which the first failure-suspected component has been estimated to include the failure location in the failure-suspected component extraction process; and an optical transmission line having a second wavelength adjacent to the first wavelength.

4. The optical transmission system according to claim 1,
wherein each of the one or more monitoring parts in the extracted failure-suspected component observes, in the failure location identification process, the temporal change of the signal information in a period of a predetermined length before and after a time point at which a signal based on which the failure-suspected component has been estimated to include the failure location has been collected.

5. The optical transmission system according to claim 1,
wherein each of the one or more monitoring parts in the extracted failure-suspected component determines, in the failure location identification process, the abnormality of the temporal change of the signal information using, as a reference, a range of a temporal fluctuation in a period not including a time point at which a signal based on which the failure-suspected component has been estimated to include the failure location has been collected.

6. A failure location identification method of identifying a failure location of an optical transmission system including a plurality of nodes connected to each other by optical transmission lines, the failure location identification method comprising:
a collection step of collecting, for each of the plurality of nodes, signal information in time series at at least one signal collection point of a transmission end of the node, a reception end of the node, and a location at or between devices in the node;
a failure-suspected component extraction step of, for a component including one or more of the plurality of nodes and zero or more optical transmission lines between the one or more of the plurality of nodes, observing signal information on a reception end of the component to extract the component as a failure-suspected component estimated to include a failure location, and
a failure location identification step of identifying the failure location in the extracted failure-suspected component by observing a temporal change of the signal information at the at least one signal collection point in each of the one or more of the plurality of nodes to detect an abnormality of the temporal change of the signal information.

7. The failure location identification method according to claim 6,
wherein the failure-suspected component estimated to include the failure location is a first failure-suspected component, and
wherein when the failure location is not identified from the first failure-suspected component by the failure location identification step, the failure location identification step is performed on a second failure-suspected component other than the first failure-suspected component, the second failure-suspected component including at least one of: one or more optical transmission lines having a first wavelength of a signal based on which the first failure-suspected component has been estimated to include the failure location in the failure-suspected component extraction step; and an optical transmission line having a second wavelength adjacent to the first wavelength.
